(19) United States
(12) Patent Application Publication
(10) Pub. No.: US 2014/0203021 A1
(43) Pub. Date: Jul. 24, 2014

(54) CONTAINER FOR DISPENSING PILLS

(71) Applicant: MAVIS, LLC, Mesa, AZ (US)

(72) Inventor: Robin H. Zill, Mesa, AZ (US)

(73) Assignee: MAVIS, LLC, Mesa, AZ (US)

(21) Appl. No.: 14/160,260

(22) Filed: Jan. 21, 2014

Related U.S. Application Data
(60) Provisional application No. 61/849,254, filed on Jan. 23, 2013.

(51) Int. Cl. A61J 7/00

(52) U.S. Cl. CPC A61J 7/0084
USPC 220/500; 29/428

(57) ABSTRACT

A container for dispensing pills is disclosed. The container holds a plurality of receptacles, where each receptacle holds a portion of pills. The receptacles set on a rotating base, where the rotation of the rotating base is controlled by a timing mechanism. The rotating base and the receptacles are enclosed in the container, covered by a lid. The lid covers most of the receptacles. The lid is locked onto the container body to control access to the receptacles. The lid has an opening large enough that one or more of the receptacles may be removed from the container through the opening. When the timing mechanism indicates that a time for dispensing pills has arrived, the timing mechanism instructs the rotating base to rotate to a position in which a receptacle is beneath the opening. The receptacle may then be removed from the container and the pills consumed.

### CROSS REFERENCE TO RELATED APPLICATIONS

This application claims priority to U.S. patent application Ser. No. 61/849,254, filed Jan. 23, 2013, by Robin Hazel Zill-Leon, and entitled “M.A.V.I.S”, which is incorporated herein by reference in its entirety.

### BACKGROUND OF THE INVENTION

1. Technical Field

This invention relates to medical and health devices and specifically to a container for dispensing pills.

2. State of the Art

Many individuals consume some form of pills, often at regular timed intervals. The pills can be medications, vitamins, or other health supplements. There is a need for a device which contains and organizes the pills for the individual, and provides the pills for consumption at a prescribed time. Various containers and storage devices exist for pills, some of which have individualized compartments for dividing up the pills into dosages to be taken at certain times. But these containers allow full access to many dosages of pills. They do not provide control over the number of pills available at any point in time. An individual can, intentionally or unintentionally, remove more than the prescribed number of pills from the container for consumption at any time. Additionally, the container does not control the times that pills are accessible to the user. This can easily lead to mistakes in the intake of the pills, where too many or too few pills are taken, or the pills are taken at the wrong time.

Accordingly, what is needed is a container for dispensing pills, where the container controls the amount of pills made available to a patient and the time that the pills are made available to the patient.

### BRIEF DESCRIPTION OF THE DRAWINGS

FIG. 1 shows a perspective view of one embodiment of container 110 according to the invention.

FIG. 2 shows a block diagram of an embodiment of container 110 of FIG. 1.

FIG. 3 shows a top view of container 110 of FIG. 1.

FIG. 4 shows a top view of container 110 of FIG. 1, with internal components shown in dotted lines.

FIG. 5 shows container 110 of FIG. 1 with all of its lids removed.

FIG. 6 shows several views of an embodiment of receptacle 131.

FIG. 7 shows a top view of an embodiment of rotating base 140 holding plurality of receptacles 130.

FIG. 8 shows a side view of rotating base 140 coupled to motor 142 using motor shaft 166, and plurality of receptacles 130 being placed on rotating base 140.

FIG. 9 shows a side view of rotating base 140 coupled to motor 142 using motor shaft 166, and plurality of receptacles 130 being held by rotating base 140.

FIG. 10 shows a top view of first lid 124 over rotating base 140 and plurality of receptacles 130, with other elements of container 110 not shown for clarity. Rotating base 140 is in a first position where first receptacle 131 can be removed from container 110 through opening 144.

FIG. 11 shows first lid 124 over rotating base 140 and plurality of receptacles 130, where rotating base 140 is rotating from the first position where first receptacle 131 can be removed from container 110 through opening 144, to a second position where second receptacle 132 can be removed from container 110 through opening 144.

FIG. 12 shows a top view of first lid 124 over rotating base 140 and plurality of receptacles 130, with other elements of container 110 not shown for clarity. Rotating base 140 is in the second position where second receptacle 132 can be removed from container 110 through opening 144.

FIG. 13 shows method 200 of forming a dispenser for pills.

### DETAILED DESCRIPTION OF EMBODIMENTS OF THE INVENTION

As discussed above, embodiments of the present invention relate to medical and health devices and specifically to a container for dispensing pills. Disclosed is a container for dispensing pills that controls when pills are made available to a patient and controls the number of pills made available to the patient. Various types of containers for pills are available. These containers hold, and in some cases organize, pills so that it is easier for the patient to obtain a certain number of pills and take them at the correct time. But while these containers help the patient organize pills and divide them up into different dosages, they do not restrict the number of pills available at any specific time nor do they control the time that different pills are made available. The disclosed container includes a rotating base that holds a number of pill receptacles. The receptacles are placed on the rotating base, and the rotating base is held with the container. Each receptacle is filled with the pills that are meant to be taken at a certain time. A lid is placed over the rotating base, where the lid has an opening that allows access to one or more of the receptacles, while blocking access to the other receptacles. The rotation of the rotating base is controlled by a timing mechanism. The timing mechanism is programmed to place each specific pill receptacle beneath the opening at the predetermined time the pills in the receptacle are meant to be consumed by the patient. The container for dispensing pills includes an alarm that will alert the patient when it is time to take the pills. At predetermined times for taking pills, a receptacle is moved by rotation of the base such that the receptacle is beneath the opening in the lid. The receptacle may then be removed from the container and its pills consumed by the patient. Access to the pills in other receptacles within the container is blocked. The container presents the pills within each receptacle for access when the patient is supposed to take the pills.

The receptacles can be filled and the timing mechanism and rotation of the base can be programmed, either by the patient or by a health professional, depending on the capabilities of the patient. In this way, the container for dispensing pills reminds the patient when to take pills and provides access to only the pills that are supposed to be taken at that particular time. This assists the patient in taking the proper number of the proper pills at the proper time.

Currently the administration of pills is controlled in a number of ways. When a patient is hospitalized or otherwise under the control of a health professional, the health professional controls the amount and timing of pill intake. A patient will receive a visit from a health professional at the proper time for taking pills. The health professional will be responsible for dispensing the proper number and type of pills at the prescribed time and will see that the pills are consumed by the patient. When patients leave the control of health professionals, they receive prescriptions in containers which provide instructions on the number and timing of taking pills. Sometimes patients receive training in self-administering the proper dosage of pills at the proper time. However, often it is too easy for patients to miss taking pills at the right time, or to take the wrong pills or the wrong number.

Many patients will benefit from an automated device that controls their pill consumption. They may have a medical condition which makes them forgetful or confused, and yet not have the benefit of a health professional constantly present to help them manage their pill intake. Even healthy, well-intentioned individuals can be too busy to consistently remember when and what pills to take at specific times. Thus a container for dispensing pills has been developed which includes receptacles for holding the proper dosage of pills. The container includes a timing mechanism that instructs the container to present the proper dosage of pills to the patient at a predetermined time for taking the pills. The container for dispensing pills provides an increased level of control and management of pill dispensing for a patient, without the need for a human health professional to be present each time pills need to be taken.

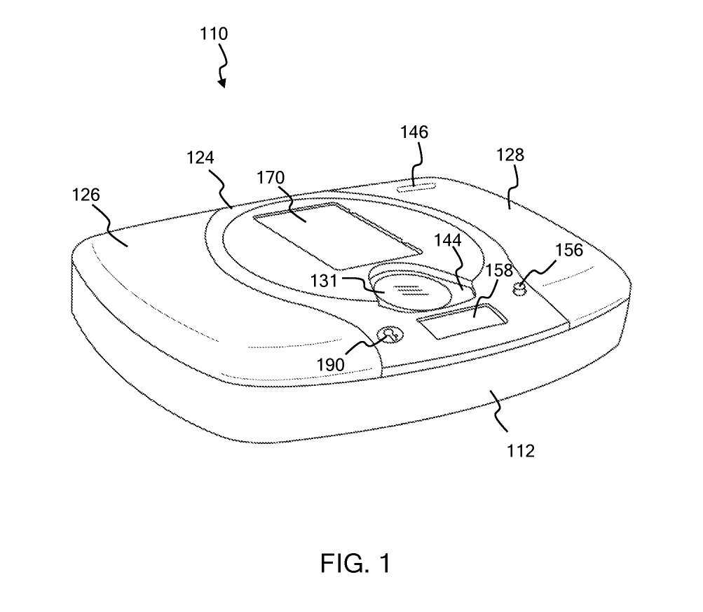

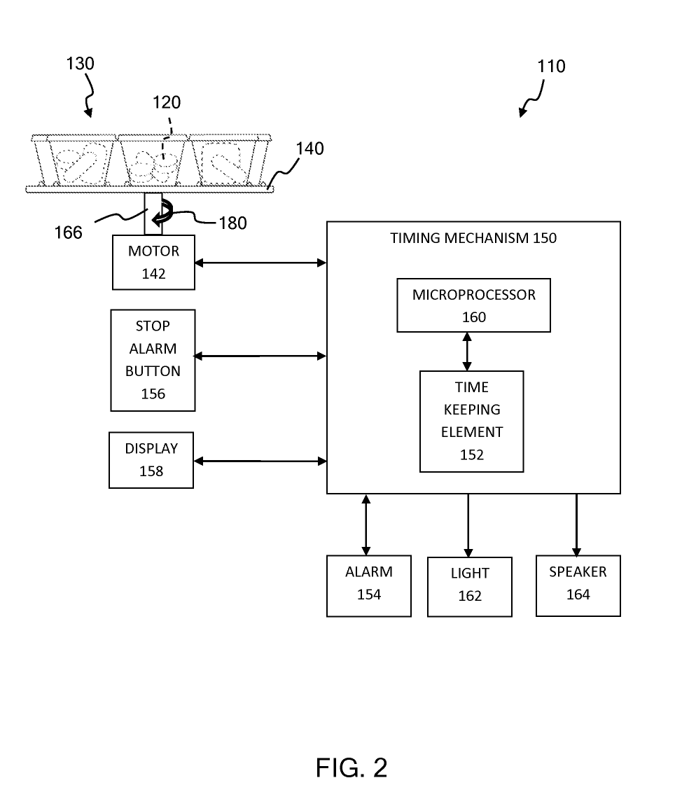

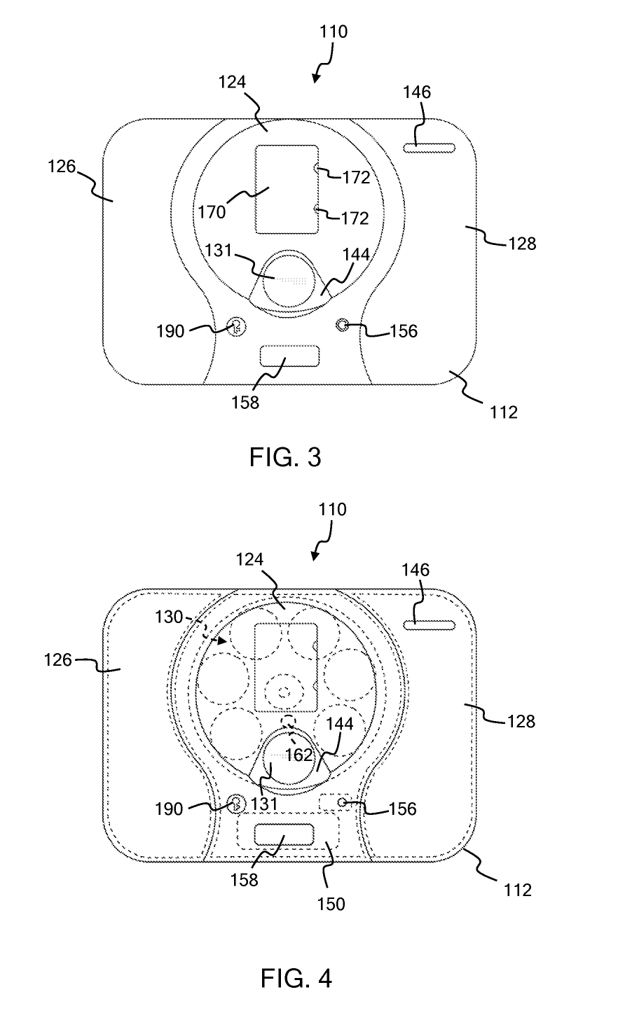

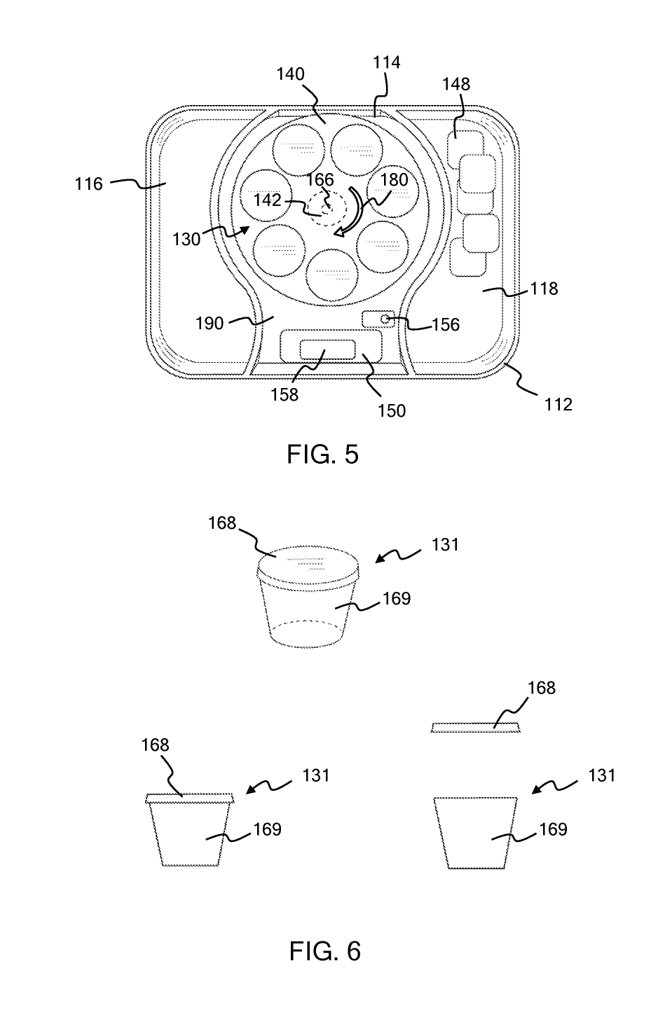

FIG. 1 through FIG. 5 shows one embodiment of container 110 for dispensing pills 120. Container 110 holds pills 120 and dispenses pills 120 to a patient at predetermined times for dispensing pills. Container 110 is also referred to as container for storing pills 110 and pill dispenser 110. FIG. 1 shows a perspective view of an embodiment of container 110. FIG. 2 shows a block diagram of one embodiment of container 110 of FIG. 1. FIG. 3 shows a top view of container 110. FIG. 4 shows a top view of container 110 with some internal components shown in dotted lines. FIG. 5 shows a top view of container 110 with its compartment lids 124, 126, and 128 removed so the inside of container 110 can be seen.

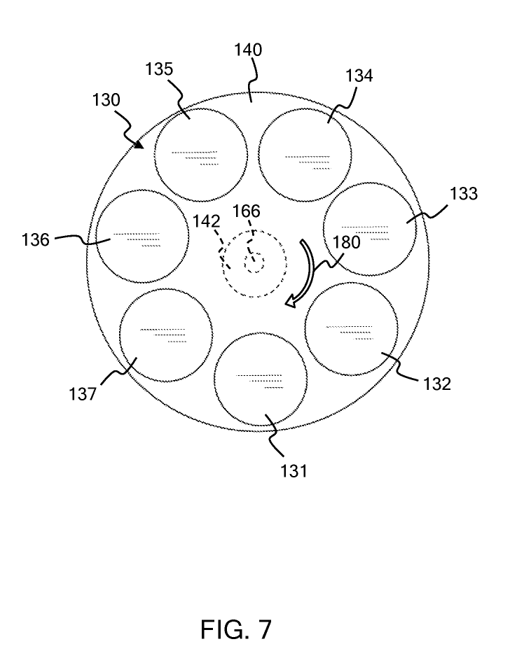

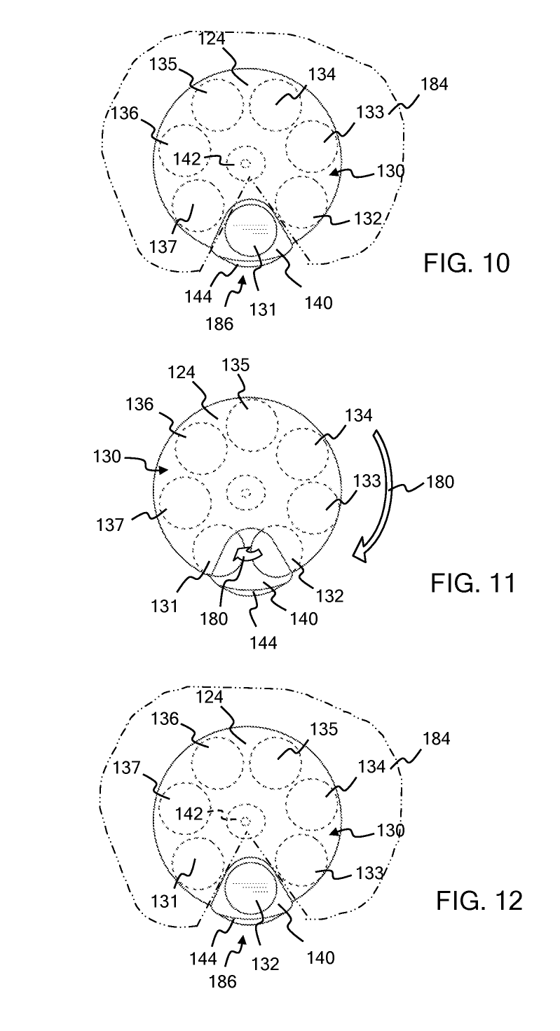

FIG. 6 shows an embodiment of receptacles 131 used to hold pills 120. FIG. 7 through FIG. 9 show how rotating base 140 holds plurality of receptacles 130, and FIG. 10 through FIG. 12 show how rotating base 140 rotates beneath lid 124 to make different specific ones of the plurality of receptacles 130 available to the patient through opening 144 in lid 124. In some embodiments opening 144 is large enough for one of plurality of receptacles 130 to pass through opening 144. In some embodiments opening 144 is large enough for one or more than one of plurality of receptacles 130 to pass through opening 144.

Container 110 includes container body 112. Container body 112 holds rotating base 140, motor 142, and time keeping mechanism 150. Rotating base 140 holds plurality of receptacles 130. Each individual one of the plurality of receptacles 130 holds a portion of pills 120. Motor 142 rotates rotating base 140, and time keeping mechanism 150 controls motor 142.

Container body 112 in the embodiment shown in the figures includes three compartments, each with their own lid. Container 112 in this embodiment includes first compartment 114 with first lid 124, second compartment 116 with second lid 126, and third compartment 118 with third lid 128. In this embodiment first compartment 114 is in the center, with second compartment 116 and third compartment 118 on either side of first compartment 114, but this is not meant to be limiting. First compartment 114, second compartment 116, and third compartment 118 can be positioned in any location as part of container body 112.

In this embodiment first compartment 114 contains rotating base 140, plurality of receptacles 130, motor 142, and time keeping mechanism 150. It is to be understood, however, that these components can be contained in any of the compartments of container 110. In this embodiment container 110 includes three compartments, but it is to be understood that container 110 can include any number of compartments. In some embodiments, container 110 includes one compartment only, where this one compartment includes rotating base 140, plurality of receptacles 130, motor 142, and time keeping mechanism 150. In some embodiments container 110 includes two compartments or more than three compartments, with one or more of the compartments containing rotating base 140, plurality of receptacles 130, motor 142, and time keeping mechanism 150.

In the embodiment shown in the figures, first compartment 114 contains rotating base 140, motor 142, plurality of receptacles 130, and time keeping mechanism 150. Rotating base 140 is rotatably coupled to container body 112. In this embodiment rotating base 140 is rotatably coupled to container body 112 in first compartment 114. Motor 142 is mechanically coupled to container body 112 in first compartment 114, and rotating base 140 is rotatably coupled to motor 142 via rotating shaft 166, as shown in FIG. 9. Motor 142 holds rotating base 140 in first compartment 114 such that motor 142 can rotate rotating base 140.

Rotating base 140 holds plurality of receptacles 130, as shown in the figures. Each one of the plurality of receptacles 130 holds a portion of pills 120. In this embodiment, some of the individual receptacles that comprise plurality of receptacles 130 hold tokens 148. Tokens 148 can be used to prompt a patient to administer treatment or forms of medication other than pills. For example, a token 148 may say “take insulin”, or “change bandage,” or any other prompt or instruction which reminds a patient that some form of treatment is required at a particular time. Tokens 148 can be used to prompt the patient to perform any act which the patient might want or need to be reminded of at a specific time, not just medical or health reminders. In this specific embodiment, however, tokens 148 are used to provide health reminders to the patient. In the embodiment shown, tokens 148 are stored in third compartment 118. In this embodiment, third lid 128 has a token opening 146 which receives tokens 148. Tokens 148 slid through token opening 146 are received by and contained within third compartment 118 until needed again.

Container 110 in the embodiments shown includes three compartments. First compartment 114 contains rotating base 140 and plurality of receptacles 130. Second compartment 116 can be used to contain syringes, patches, thermometers, bandages, personal items, or other items that are needed for administering pills 120 or treatments indicated by tokens 148. Third compartment 118 in the embodiment shown is used to store tokens 148. It is to be understood that many other configurations and uses of the compartments according to the invention are possible. A greater or lesser number of compartments can be used in container 110, and they can be used for different purposes other than dispensing pills 120.

FIG. 6 shows an embodiment of receptacle 131. Receptacle 131 is one of plurality of receptacles 130. Receptacle 131 in this embodiment includes receptacle body 169 and receptacle lid 168. In some embodiments, receptacle 131 is used without lid 168. Receptacle 131 can take any form, size, color, shape—with or without lids, etc.—that is suitable to hold a portion of pills 120 and tokens 148 needed to be dispensed at a predetermined time.

FIG. 7 shows a top view of rotating base 140 and plurality of receptacles 130. In this embodiment, the plurality of receptacles 130 includes first receptacle 131, second receptacle 132, third receptacle 133, fourth receptacle 134, fifth receptacle 135, sixth receptacle 136, and seventh receptacle 137. In some embodiments, there are a number of receptacles more or less than seven in the plurality of receptacles 130.

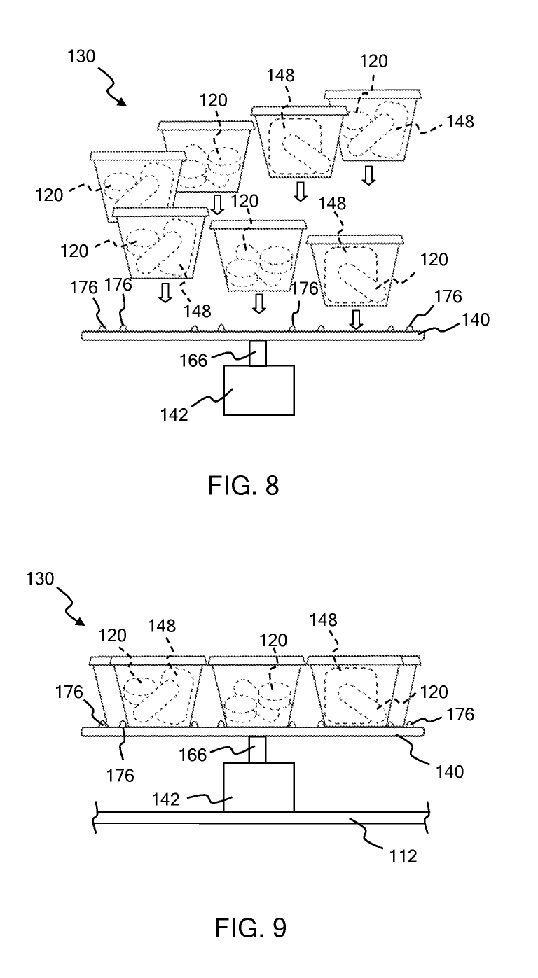

Pills 120 and tokens 148 are placed into the plurality of receptacles 130 by the patient, or by a health professional if the patient is unwilling or unable. Each individual receptacle of the plurality of receptacles 130 receives a portion of pills or tokens 148 that should be administered at a particular time. Plurality of receptacles 130 are placed on rotating base 140 as shown in FIG. 8 and FIG. 9. Plurality of receptacles 130 are placed in order on rotating base 140 so that each individual receptacle of plurality of receptacles 130 is successively presented to the patient at the predetermined time for the pills 120 and tokens 148 to be administered, as explained below. Raised nubs 176 hold each individual receptacle of the plurality of receptacles 130 in its place on rotating base 140.

It is to be understood that plurality of receptacles 130 and rotating base 140 can take many forms. In some embodiments, each individual receptacle of the plurality of receptacles 130 is coupled to rotating base 140. In some embodiments, each individual receptacle of the plurality of receptacles 130 is formed as a part of rotating base 140. In some embodiments, each individual receptacle of the plurality of receptacles 130 is not removable from rotating base 140. In the embodiment shown in the figures, each individual receptacle of the plurality of receptacles 130 sets on rotating base 140.

Container 110 in the embodiment shown in the figures includes first lid 124 over first compartment 114, second lid 126 over second compartment 116 and third lid 128 over third compartment 118. Second lid 126 in the embodiment shown covers second compartment 116. Second lid 126 in this embodiment is coupled to container body 112 in such a way that access to second compartment 116 is not restricted. In this embodiment, second lid 126 is hingedly coupled to container body 112. In this embodiment, the patient can open or close second lid 126 at will to access or use second compartment 116. In some embodiments, second lid 126 is locked to container body 112 to restrict access to second compartment 116. In some embodiments, second lid 126 is coupled to container body 112 in other ways to restrict or not restrict access to second compartment 116.

Third lid 128 in the embodiment shown covers third compartment 118. Third lid 128 in this embodiment is coupled to container body 112 in such a way that access to third compartment 118 is not restricted. In this embodiment, third lid 128 is hingedly coupled to container body 112. In this embodiment, the patient can open or close third lid 128 at will to access or use third compartment 118. In some embodiments, third lid 128 is locked to container body 112 to restrict access to third compartment 118. In some embodiments third lid 128 is coupled to container body 112 in other ways to restrict or not restrict access to third compartment 118. In this embodiment, third compartment 118 is used to store tokens 148. Third lid 128 includes token opening 146 as described earlier for inserting tokens 148 into third compartment 118 without having to remove or open third lid 128.

In the embodiment of container 110 shown in the figures, first lid 124 covers first compartment 114. First lid 124 is locked to container body 112 with key lock 190 so that access to plurality of receptacles 130 is controlled. First compartment 114 contains motor 142, rotating base 140, plurality of receptacles 130, and timing mechanism 150, as shown in FIG. 1 through FIG. 5. First lid 124 in this embodiment includes inset area 170. Inset area 170 can be used to hold business cards, photos, or other thin personal items. Inset area 170 can be used to hold business cards such as the card of a doctor, for example. Tabs 172 (FIG. 3) are used to hold paper items such as business cards and photos inside of inset area 170. Inset area 170 can be used to hold a photo or picture to personalize container 110.

First lid 124 covers a first portion 184 of plurality of receptacles 130, while leaving a second portion 186 of plurality of receptacles 130 exposed, as shown in FIG. 10 through FIG. 12. First lid 124 includes opening 144. The first portion 184 of plurality of receptacles 130 which are not beneath opening 144 are covered by first lid 124 and cannot be removed from container 110 without unlocking lid 124. The second portion 186 of plurality of receptacles 130, which are those receptacles that are beneath opening 144, are exposed and can be removed from container 110 by the patient, through opening 144. Opening 144 is large enough in this embodiment for one or more of the individual receptacles comprising plurality of receptacles 130 to pass through opening 144.

FIG. 10 through FIG. 12 show first lid 124 and plurality of receptacles 130 on rotating base 140. The other elements of container 110 are not shown in FIG. 10 through FIG. 12 for clarity. Rotating base 140 is rotated by motor 142 through rotating shaft 166 in this embodiment, but this is not meant to be limiting. Rotating base 140 can be rotated by motor 142, or any other device, using any means for controlling the rotation of rotating base 140.

Plurality of receptacles 130 are set on rotating base 140. First lid 124 covers the first portion 184 of plurality of receptacles 130, as shown in FIG. 10. First portion 184 comprises those receptacles that are not positioned beneath opening 144. Plurality of receptacles 130 in this embodiment includes seven receptacles, receptacles 131 through 137. FIG. 10 shows rotating base 140 in a first position, where first portion 184 of plurality of receptacles 130 includes six receptacles, receptacles 132 through 137, and second portion 186 of plurality of receptacles 130 includes one receptacle, receptacle 131. First portion 184 of plurality of receptacles 130 is covered by first lid 124 and cannot be removed from container 110 when rotating base 140 is in the first position as shown in FIG. 10. First portion 184 of plurality of receptacles 130 are not positioned beneath opening 144 and so cannot be removed from container 110 through opening 144 when rotating base 140 is in the first position as shown in FIG. 10.

With rotating base 140 in the first position as shown in FIG. 10, second portion 186 of plurality of receptacles 130 is beneath opening 144. Second portion 186 of plurality of receptacles 130 is positioned beneath opening 144 and is exposed. Receptacle 131 can be removed from container 110 through opening 144 when receptacle 131 is positioned beneath opening 144. Second portion 186 of plurality of receptacles 130, which in this embodiment includes receptacle 131, is exposed and can be removed from container 110 in response to rotating base 140 rotated to the first position in which second portion 186, which includes receptacle 131 of plurality of receptacles 130, is placed beneath opening 144.

In the embodiment shown in the figures, first portion 184 of plurality of receptacles 130 includes six receptacles of plurality of receptacles 130, and second portion 186 of plurality of receptacles 130 includes only one receptacle of plurality of receptacles 130, but this is not meant to be limiting. It is to be understood that each of plurality of receptacles 130, lid 124, opening 144, and rotating base 140 can be sized and shaped such that any desired proportion or number of plurality of receptacles 130 can be included in first portion 184 or second portion 186 and be covered or exposed at particular positions of rotating base 140.

FIG. 11 shows first lid 124 and plurality of receptacles 130 on rotating base 140, as in FIG. 10. In FIG. 11, however, rotating base 140 is rotating from the first position shown in FIG. 10 to the second position shown in FIG. 12. Rotating base 140 rotates clockwise in this embodiment, but this is not meant to be limiting. Rotating base 140 can rotate either direction to move a specific receptacle beneath opening 144, exposing the specific receptacle and allowing the patient to remove the specific receptacle from container 110 through opening 144.

FIG. 12 shows first lid 124 and plurality of receptacles 130 on rotating base 140, with rotating base 140 in a second position where receptacle 132 is beneath opening 144. When rotating base 140 is in the second position as shown in FIG. 12, first portion 184 of plurality of receptacles 130 includes receptacle 131 and receptacles 133-137. First portion 184 of plurality of receptacles 130 are covered by lid 124 and cannot be accessed or removed from container 110 without unlocking lid 124. When rotating base 140 is in the second position as shown in FIG. 12, first lid 124 covers first portion 184 of plurality of receptacles 130, where first portion 184 includes receptacle 131 and receptacles 133-137. Lid 124 covers first portion 184 of plurality of receptacles and leaves second portion 186 of plurality of receptacles exposed.

When rotating base 140 is in the second position as shown in FIG. 12, second portion 186 of plurality of receptacles 130 includes second receptacle 132. Second receptacle 132 is positioned beneath opening 144 when rotating base 140 is in the second position. Second receptacle 132 can be removed from container 110 by the patient and the pills 120 in second receptacle 132 can be accessed and consumed when rotating base 140 is in the second position. When rotating base 140 is in the second position as shown in FIG. 12, second portion 186—which in FIG. 12 is receptacle 132—is placed beneath opening 144 and is exposed.

Any particular one of the plurality of receptacles 130 can be removed from container 110 through opening 144 in response to motor 142 rotating the rotating base 140 to a first position in which the particular receptacle is positioned beneath opening 144. Any particular one of the plurality of receptacles 130 cannot be removed from container 110 through opening 144 in response to motor 142 rotating the rotating base 140 to a second position in which the particular receptacle is not positioned beneath opening 144. For example, receptacle 131 can be removed from container 110 through opening 144 in response to motor 142 rotating the rotating base 140 to a first position in which receptacle 131 is positioned beneath opening 144, as shown in FIG. 10. And receptacle 131 cannot be removed from container 110 through opening 144 in response to motor 142 rotating the rotating base 140 to a second position in which receptacle 131 is not positioned beneath opening 144, as shown in FIG. 12.

Container 110 includes timing mechanism 150. Motor 142 is electrically coupled to timing mechanism 150. Motor 142 is controlled by timing mechanism 150. Timing mechanism 150 is programmed to place a specific one of the plurality of receptacles 130 in a position beneath opening 144 when a predetermined time for the patient to consume pills 120 in the specific receptacle arrives.

Timing mechanism 150 includes time keeping element 152, which in this embodiment is a quartz crystal resonator. Timing mechanism 150 also includes microprocessor 160, as shown in FIG. 2. Timing mechanism 150 can be any type of timing mechanism, such as is used in alarm clocks, watches, digital clocks, etc. In this embodiment, timing mechanism 150 controls motor 142, stop alarm button 156, light 162, display 158, alarm 154, and speaker 164. Microprocessor 160 is the brains of timing mechanism 150 and controls time keeping element 152, motor 42, alarm 154, display 158, stop alarm button 156, light 162, and speaker 164. Alarm 154 is electrically coupled to timing mechanism 150. Microprocessor 160 is programmed to sound alarm 154 through speaker 164 when a predetermined time for dispensing pills is reached by time keeping element 152. Timing mechanism 150 activates alarm 154 in response to time keeping element 152 of timing mechanism 150 reaching a predetermined time for dispensing pills. In this embodiment, processor 160 is programmed to turn on light 162 when the predetermined time is reached by time keeping element 152. Alarm 154 and light 162 can both—or one or the other—be used as an indicator to the patient that it is time to take pills 120. Some patients may prefer or be better adapted to sounds and will want to use alarm 154. Other patients may prefer or be better adapted to light and will want to use light 162. In this embodiment, light 162 is positioned by opening 144 (see FIG. 4) and will illuminate opening 144 and second portion 186 of plurality of receptacles 130 that are exposed beneath opening 144. Light 144 will help the patient see opening 144 and can be useful for patients who do not hear well.

Microprocessor 160 causes motor 142 to rotate the rotating base 140 when time keeping element 152 indicates that a predetermined time for the patient to take pills has arrived.

Stop alarm button 156 extends through first lid 124. Stop alarm button 156 is electrically coupled to timing mechanism 150. In some embodiments timing mechanism 150 turns off alarm 154 in response to stop alarm button 156 being activated. Alarm 154 is turned off when stop alarm button 156 is activated. In this embodiment, stop alarm button 156 is activated when it is pushed by the patient.

Timing mechanism 150 in this embodiment is programmed like an alarm clock to activate alarm 154 and/or light 162 when time keeping element 152 indicates that a predetermined time for dispensing pills 120 has arrived. In some embodiments, timing mechanism 150 instructs motor 142 to rotate the rotating base 140 in response to timing mechanism 150 indicating the arrival of a predetermined time to dispense pills 120 to the patient. In some embodiments, timing mechanism 150 controls motor 142 in such a way that timing mechanism 150 instructs motor 142 to move to the first position as shown in FIG. 10 at a predetermined time for dispensing pills 120. In this example, when timing mechanism 150 determines the arrival of the predetermined time to dispense pills 120, timing mechanism 150 will activate alarm 154 and light 162. The patient will be alerted that it is time to take pills by alarm 154 and/or light 162. The patient can remove first receptacle 131 through opening 144 because first receptacle 144 will be beneath opening 144 as shown in FIG. 10. The patient can use stop alarm button 156 to turn off alarm 154 and light 162. The patient can remove pills 120 from receptacle 131 for consumption, and can perform any tasks indicated on tokens 148 that are inside receptacle 131. Receptacle 131 can be replaced in container 110 or can be stored elsewhere until container 110 is refilled either by the patient or by a health professional. Rotating base 140 will stay in the first position until timing mechanism 150 indicates that the next predetermined time for taking pills has arrived. When the next predetermined time for taking pills arrives, timing mechanism 150 will instruct motor 142 to rotate the rotating base 140 to a second position as shown in FIG. 11 and FIG. 12. In this embodiment timing mechanism 150 instructs motor 142 to rotate the rotating base 140 in response to time keeping element 152 indicating an arrival of a predetermined time to dispense pills. Receptacle 132 is available for access through opening 144 when rotating base 140 is in the second position as shown in FIG. 12, and the patient will remove receptacle 132 and consume its portion of pills 120. This may be repeated until all of the portions of pills 120 in plurality of receptacles 130 have been consumed. In these example embodiments, timing mechanism 150 instructs motor 142 to rotate the rotating base 140 in response to time keeping element 152 indicating an arrival of a predetermined time to dispense pills.

Once all of plurality of receptacles 130 has been emptied of their pills and tokens, or when otherwise desired, either the patient or a health professional can reload container 110 by using lock 190 to remove first lid 124. Plurality of receptacles 130 can be refilled with pills 120 and/or tokens 148, and timing mechanism 150 can be programmed to dispense pills 120 and/or tokens 148 at proper times.

In the example above, timing mechanism 150 instructs motor 142 to rotate the rotating base 140 to the first position, the second position, etc., when the predetermined time to dispense pills 120 has arrived and at the same time that alarm 154 and/or light 162 is activated. But this is only an example and is not meant to be limiting. In some embodiments, timing mechanism 150 is programmed to instruct motor 142 to rotate the rotating base 140 to the first position (the second position, etc.,) in response to stop alarm button 156 being pushed. In this second example, alarm 154 and/or light 162 will activate when timing mechanism 150 indicates the arrival of a predetermined time to dispense pills 120. The patient will see/hear that it is time to take pills and will push stop alarm button 156. Once stop alarm button 156 is pushed, timing mechanism 150 will instruct motor 142 to rotate the rotating base 140 to the first position (second position, etc.) in response to the stop alarm button 156 being pushed. In the second example, timing mechanism 150 is programmed to instruct motor 142 to rotate the rotating base 140 in response to stop alarm button 156 being pushed; whereas in the previous example, timing mechanism 150 was programmed to instruct motor 142 to rotate the rotating base 140 in response to the arrival of the predetermined time to dispense pills. It is to be understood that these are examples only of the possible programming options of timing mechanism 150 and its control of motor 142. Many other programming options are possible for container 110 according to the invention.

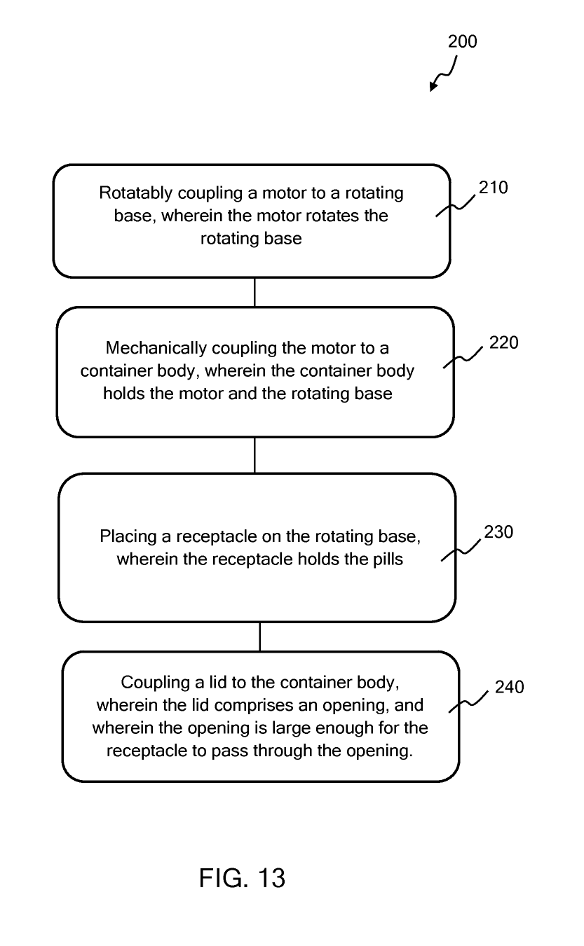

FIG. 13 shows method 200 of forming a container for pills. Method 200 of forming a container for pills in the embodiment shown in FIG. 13 includes step 210 of rotatably coupling a motor to a rotating base, where the motor rotates the rotating base. Method 200 also includes step 220 of mechanically coupling the motor to a container body, where the container body holds the motor and the rotating base. Method 200 also includes step 230 of placing a receptacle on the rotating base, where the receptacle holds the pills. Method 200 also includes step 240 of coupling a lid to the container body, where the lid comprises an opening, and where the opening is large enough for the receptacle to pass through the opening. In some embodiments of method 200, the receptacle can be removed from the container through the opening in response to the motor rotating the rotating base to a first position, and the receptacle cannot be removed from the container through the opening in response to the motor rotating the rotating base to a second position. In some embodiments of method 200 the opening allows the receptacle to be removed from the container through the opening in response to the motor rotating the rotating base to a first position in which the receptacle is positioned beneath the opening. In some embodiments the lid restricts the receptacle from being removed from the container through the opening in response to the motor rotating the rotating base to a second position in which the receptacle is not positioned beneath the opening.

In some embodiments, coupling the lid to the container body comprises locking the lid to the container body with a key lock. In some embodiments the receptacle is a plurality of receptacles including a first portion of the plurality of receptacles and a second portion of the plurality of receptacles. In some embodiments the lid restricts access to the first portion of a plurality of receptacles by covering the first portion of the plurality of receptacles.

In some embodiments, the lid allows access to the second portion of the plurality of receptacles by allowing the second portion of the plurality of receptacles to be removed through the opening. In some embodiments the second portion of the plurality of receptacles is exposed in response to the rotating base being in a position in which the second portion of the plurality of receptacles is placed beneath the opening.

Method 200 can include many other steps. In some embodiments, method 200 includes controlling the motor with a timing mechanism, where the timing mechanism instructs the motor to move the rotating base to the first position at a predetermined time for dispensing pills. In some embodiments, method 200 includes coupling a light to the container body, where the light illuminates the opening in response to the alarm being activated. In some embodiments, method 200 includes controlling the motor with a timing mechanism. In some embodiments method 200 includes coupling an alarm to the timing mechanism. In some embodiments, method 200 includes programming the timing mechanism to activate the alarm in response to the timing mechanism indicating the arrival of a predetermined time to dispense pills. In some embodiments, method 200 includes coupling a stop alarm button to the timing mechanism, where the timing mechanism deactivates the alarm in response to the stop alarm button being pushed. In some embodiments, method 200 includes programming the timing mechanism to instruct the motor to rotate the rotating base to the first position in response to the stop alarm button being pushed.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

1. A container for storing pills, the container comprising:
a container body, wherein the container body comprises:
a first compartment with a first lid;
a second compartment with a second lid;
and
a third compartment with a third lid; and
a rotating base contained within the first compartment, wherein the rotating base holds a plurality of receptacles, and wherein each one of the plurality of receptacles holds a portion of pills.

2. The container of claim 1, further comprising a motor mechanically coupled to the container body and the rotating base, wherein the motor rotates the rotating base.

3. The container of claim 2, further comprising a timing mechanism, wherein the timing mechanism controls the motor.

4. The container of claim 3, wherein the timing mechanism comprises a time keeping element, and wherein the container further comprises:
an alarm electrically coupled to the timing mechanism, wherein the timing mechanism activates the alarm in response to the time keeping element indicating an arrival of a predetermined time for dispensing pills;
and
a stop alarm button electrically coupled to the timing mechanism, wherein the timing mechanism turns off the alarm in response to the stop alarm button being activated.

5. The container of claim 4, wherein the timing mechanism instructs the motor to rotate the rotating base in response to the stop alarm button being activated.

6. The container of claim 5, wherein the first lid covers a first portion of the plurality of receptacles, and wherein the first lid comprises an opening, wherein a second portion of the plurality of receptacles is exposed in response to the rotating base being in a position in which the second portion of the plurality of receptacles is placed beneath the opening.

7. The container of claim 6, wherein the second portion of the plurality of receptacles is only one of the plurality of receptacles.

8. The container of claim 7, wherein the timing mechanism instructs the motor to rotate the rotating base to the position in which the second portion of the plurality of receptacles is placed beneath the opening in response to the stop alarm button being activated.

9. The container of claim 1, further comprising a token opening in the third lid, wherein a token slid through the token opening is received by the third compartment.

10. A pill dispensing container comprising:
a container body;
a rotating base rotatably coupled to the container body;
a plurality of receptacles for receiving pills, wherein each one of the plurality of receptacles sets on the rotating base; and
a lid, wherein the lid covers a first portion of the plurality of receptacles and leaves a second portion of the plurality of receptacles exposed.

11. The pill dispensing container of claim 10, wherein the second portion of the plurality of receptacles is only one of the plurality of receptacles.

12. The pill dispensing container of claim 10, wherein the lid comprises an opening, wherein the second portion of the plurality of receptacles is exposed in response to the rotating base rotating to a position in which the second portion of the plurality of receptacles is placed beneath the opening.

13. The pill dispensing container of claim 10, further comprising:
a timing mechanism comprising a time keeping element;
and
a motor electrically coupled to the timing mechanism and mechanically coupled to the rotating base, wherein the motor rotates the rotating base;
wherein the timing mechanism instructs the motor to rotate the rotating base in response to the time keeping element indicating an arrival of a predetermined time to dispense pills.

14. The pill dispensing container of claim 13, further comprising a light coupled to the timing mechanism, wherein the light is illuminated in response to the time keeping element indicating the arrival of the predetermined time to dispense pills.

15. A method of forming a container for pills, the method comprising:
rotatably coupling a motor to a rotating base, wherein motor rotates the rotating base;
mechanically coupling the motor to a container body, wherein the container body holds the motor and the rotating base;
placing a receptacle on the rotating base, wherein the receptacle holds the pills;
and
coupling a lid to the container body, wherein the lid comprises an opening, and wherein the opening is large enough for the receptacle to pass through the opening.

16. The method of claim 15, wherein the opening allows the receptacle to be removed from the container through the opening in response to the motor rotating the rotating base to a first position in which the receptacle is positioned beneath the opening; and wherein the lid restricts the receptacle from being removed from the container through the opening in response to the motor rotating the rotating base to a second position in which the receptacle is not positioned beneath the opening.

17. The method of claim 16, further comprising controlling the motor with a timing mechanism, wherein the timing mechanism instructs the motor to rotate the rotating base to the first position at a predetermined time for dispensing pills.

18. The method of claim 15, wherein coupling the lid to the container body comprises locking the lid to the container body with a key lock.

19. The method of claim 16, further comprising:
controlling the motor with a timing mechanism;
coupling an alarm to the timing mechanism;
programming the timing mechanism to activate the alarm in response to the timing mechanism indicating an arrival of a predetermined time to dispense pills;
coupling a stop alarm button to the timing mechanism, wherein the timing mechanism deactivates the alarm in response to the stop alarm button being pushed;
and
programming the timing mechanism to instruct the motor to rotate the rotating base to the first position in response to the stop alarm button being pushed.

20. The method of claim 19, further comprising coupling a light to the container body, wherein the light illuminates the opening in response to the alarm being activated.
